(19) United States
(12) Patent Application Publication
(10) Pub. No.: US 2016/0321608 A1
(43) Pub. Date: Nov. 3, 2016

(54) METHOD AND SYSTEM FOR INTERLEAVING WEBSITE-ORIGINATED ORDERS OF ARTISANAL PRODUCTS WITH IN-STORE PURCHASES

(71) Applicant: Artizone Ltd., Kfar Saba (IL)

(72) Inventors: Alexander ZELTCER, Highland Park, IL (US); Samuel SICHEL, Hod HaSharon (IL); Sagi BRITEMAN, Ra'naana (IL); Yehudit BUCHNIK, Ramat Gan (IL); Lior LAVY, Highland Park, IL (US)

(21) Appl. No.: 14/698,959

(22) Filed: Apr. 29, 2015

(51) Int. Cl. G06Q 10/08; G06Q 20/20; G06Q 30/06

(52) U.S. Cl. CPC G06Q 10/08355; G06Q 30/0635; G06Q 20/202

(57) ABSTRACT

Method and system for interleaving website-originated orders of goods with in-store purchases are provided herein. Steps of the method may include: placing, over an electronic device, an order including two or more artisanal products, associated with two or more artisans; conveying the orders of each of the artisanal products to the respective artisans, wherein the conveyed orders are interleaved with an existing stream of in-store orders at a respective store of the artisans; determining a pickup route for collecting the ordered artisanal products from the stores of the respective artisans; and collecting the artisanal products in the order and delivering the ordered artisanal products to a target destination. The system may implement the method in centralized client-server architecture.

### FIELD OF THE INVENTION

The present invention relates generally to the field of online purchase of goods, and more particularly to a tailored service of online purchase platform focusing on artisans.

### BACKGROUND OF THE INVENTION

Prior to the background of the invention being set forth, it may be helpful for definitions of certain terms that will be used hereinafter to be set forth.

The term ‘artisan” as used herein is defined as a skilled craft worker producing products in a non-industrialized manner. Thus, ‘artisanal products’ may include, for example, food, drinks, perfumes, and toys that have been produced by an artisan.

The term ‘stream of orders” as used herein is defined as a queue of orders presented at a point of sale (POS) as a store of a retailer such as an artisan.

The term ‘in-store order” or as used herein is defined as a traditional purchase occurrence carried out by a person visiting a store and physically bringing an item to the point of sale.

The term “online order” as used herein is defined as purchase occurring over a computer network such as the Internet.

One of the ongoing challenges of artisans worldwide is to be able to reach a market of consumers that will be sufficiently large to support their business. This is due to the nature of artisans as retailers, producing and selling products with short shelf life and a limited potential market.

It would be therefore advantageous to provide facilitating online purchase platform that is focused on the unique characteristics of artisan-retailers and their customers.

### SUMMARY OF THE INVENTION

Some embodiments of the present invention provide a method and system for interleaving website-originated orders of goods with in-store purchases. Steps of the method may include: placing, over an electronic device, an order including two or more artisanal products, associated with two or more artisans; conveying the orders of each of the artisanal products to the respective artisans, wherein the conveyed orders are interleaved with an existing stream of in-store orders at a respective store of the artisans; determining a pickup route for collecting the ordered artisanal products from the stores of the respective artisans; and collecting the artisanal products in the order and delivering the ordered artisanal products to a target destination. The system may implement the method in centralized client server architecture.

Some embodiments of the present invention provide a computerized platform for enabling customers to place various orders of goods, specifically gourmet food portions bought by weight with a network of small gourmet food specialized retailers.

The platform may include a user interface which includes both a catalog and purchase order functionality. A server receives all orders by customers who are usually registered to the service. The server then accumulates all orders from all customers for all registered specialized retailers.

All orders are then dispatched to the specialized retailers in the following manner: an order associated with the computerized platform is dispatched to a specific specialized retailer, among all other orders that the specialized retailer receives, including in-store purchases. Upon completion of all orders (e.g., the specialized retailer has prepared all gourmet food per the orders). The orders are being collected by transport arranged by the computerized platform wherein the collection route is being optimized for efficiency.

Advantageously, the orders originated by the computerized platform are interleaved with ordinary on-store orders of ordinary customers. This adds to the seamless manner of the purchase process from the specialized retailers' perspective.

On the customers' side, the computerized platform enables to aggregate all orders from different specialized retailers in a single ordering session. Logistically, all orders are being coordinated so that delivery of “last mile” is carried out at a single take.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an exemplary architecture on which embodiments of the present invention may be implemented; and

FIG. 2 is a flowchart diagram illustrating a method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

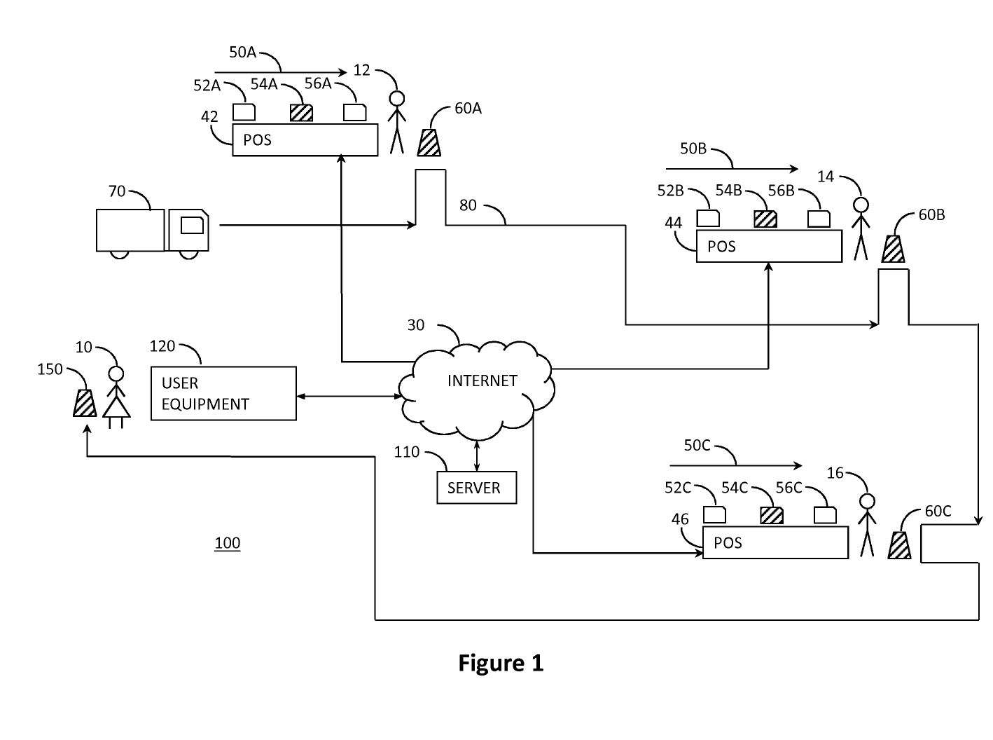

FIG. 1 is a block diagram illustrating an exemplary architecture on which embodiments of the present invention may be implemented. System 100 may include a plurality of electronic devices such as user equipment (UE) 120 configured to place, over a computerized network such as the Internet 30, at least one order such as 54A, 54B, and 54C including two or more artisanal products, associated with two or more artisans 12, 14, and 16. The system further includes a server 110 connected via Internet 30 to a plurality of point of sales (POS) 42, 44, and 46 of the respective artisans 12, 14, and 16. Server 110 may be configured to: receive the orders 54A, 54B, and 54C from the plurality of electronic devices such as UE 120, and convey the orders 52A, 52B, and 52C of each of the artisanal products to the respective artisans 12, 14, and 16, wherein the conveyed orders are interleaved with an existing stream 50A, 50B, and 50C of in-store orders such as 52A, 56A, 52B, 56B, 52C, and 56C at a respective store of the artisans 12, 14, and 16. Server 110 may be further configured to determine a pickup route 80 for collecting the ordered artisanal products 60A, 60B, and 60C from the stores of the respective artisans. Upon setting up the route 80, a delivery vehicle 70 collects ordered artisanal products 60A, 60B, and 60C and delivers them in one pack 150 to the target destination, usually user 10.

According to one embodiment of the present invention, all packages from all artisans 12, 14, and 16 are being transported to a warehouse (not shown) where the good for each user 10 is being sorted and packed together so as to enable a single package experience. Alternatively, in another embodiment, all packages are being sorted to users while collected from artisans 12, 14, and 16. This option requires no warehouse between the artisans and user 10.

According to some embodiments of the present invention, the artisans are pre-registered on a service offered to users of the service.

According to some embodiments of the present invention, the placing of the order is responsive to a selection by users over a user interface presenting artisanal products and respective artisans.

According to some embodiments of the present invention, conveying is carried out electronically over a server which consolidates a plurality of orders from a plurality of users.

According to some embodiments of the present invention, conveying is carried out based on a cost function that optimizes the pickup route.

According to some embodiments of the present invention, all artisanal products in the order are delivered to the target destination on a single delivery.

According to some embodiments of the present invention, all artisanal products in a specified order are delivered to the target destination via a single delivery vehicle.

According to some embodiments of the present invention, the conveying is carried out as orders presented at a point of sale (POS) at respective stores of the artisans within a queue containing in-store orders.

According to some embodiments of the present invention, the cost function takes into account delivery time, fuel consumption of a delivery vehicle and freshness of the goods.

According to some embodiments of the present invention, the electronic device is selected from a group including: a cellular phone, a smartphone, a personal computer (PC), a laptop PC, and a tablet PC.

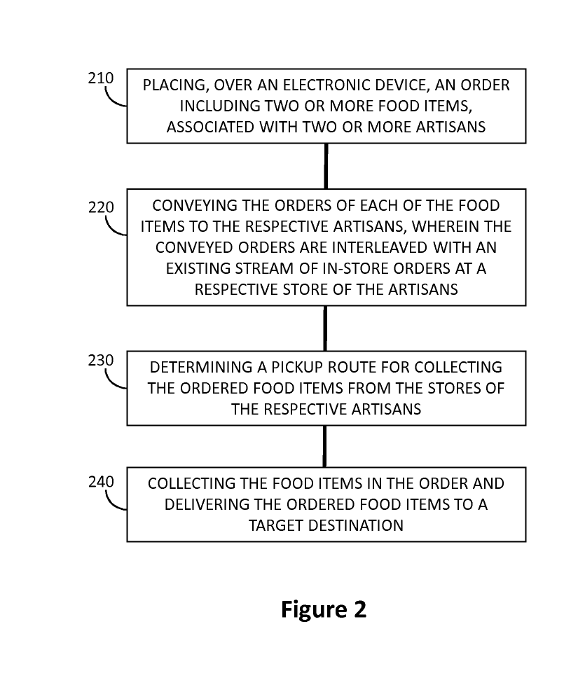

FIG. 2 is a flowchart diagram illustrating a method in accordance with embodiments of the present invention. method 200 may include the following steps: placing, over an electronic device, an order including two or more artisanal products, associated with two or more artisans 210; conveying the orders of each of the artisanal products to the respective artisans, wherein the conveyed orders are interleaved with an existing stream of in-store orders at a respective store of the artisans 220; determining a pickup route for collecting the ordered artisanal products from the stores of the respective artisans 230; and collecting the artisanal products in the order and delivering the ordered artisanal products to a target destination 240.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
placing, over an electronic device, an order including two or more artisanal products, associated with two or more artisans;
conveying the orders of each of the artisanal products to the respective artisans, wherein the conveyed orders are interleaved with an existing stream of in-store orders at a respective store of the artisans;
determining a pickup route for collecting the ordered artisanal products from the stores of the respective artisans; and
collecting the artisanal products in the order and delivering the ordered artisanal products to a target destination.

2. The method according to claim 1, wherein said artisans are pre-registered on a service offered to users of the service.

3. The method according to claim 2, wherein the placing of the order is responsive to a selection by users over a user interface presenting artisanal products and respective artisans.

4. The method according to claim 1, wherein the conveying is carried out electronically over a server which consolidates a plurality of orders from a plurality of users.

5. The method according to claim 4, wherein the conveying is carried out based on a cost function that optimizes the pickup route.

6. The method according to claim 1, wherein all artisanal products in the order are delivered to the target destination on a single delivery.

7. The method according to claim 1, wherein all artisanal products in a specified order are delivered to the target destination via a single delivery vehicle.

8. The method according to claim 1, wherein the conveying is carried out as a orders presented at a point of sale (POS) at respective stores of the artisans within a queue containing in-store orders.

9. The method according to claim 5, wherein the cost function takes into account delivery time, fuel consumption of a delivery vehicle and freshness of the goods.

10. The method according to claim 1, wherein the electronic device is selected from a group including: a cellular phone, a smartphone, a personal computer (PC), a laptop PC, and a tablet PC.

11. A system comprising:
a plurality of electronic devices configured to place, over a computerized network, at least one order including two or more artisanal products, associated with two or more artisans; and
a server configured to:
receive the orders from the plurality of electronic devices;
convey the orders of each of the artisanal products to the respective artisans, wherein the conveyed orders are interleaved with an existing stream of in-store orders at a respective store of the artisans; and
determine a pickup route for collecting the ordered artisanal products from the stores of the respective artisans.

12. The system according to claim 11, wherein said artisans are pre-registered on a service offered to users of the service.

13. The system according to claim 12, wherein the placing of the order is responsive to a selection by users over a user interface presenting artisanal products and respective artisans.

14. The system according to claim 11, wherein the conveying is carried out electronically over a server which consolidates a plurality of orders from a plurality of users.

15. The system according to claim 14, wherein the conveying is carried out based on a cost function that optimizes the pickup route.

16. The system according to claim 11, wherein all artisanal products in the order are delivered to the target destination on a single delivery.

17. The system according to claim 11, wherein all artisanal products in a specified order are delivered to the target destination via a single delivery vehicle.

18. The system according to claim 11, wherein the conveying is carried out as a orders presented at a point of sale (POS) at respective stores of the artisans within a queue containing in-store orders.

19. The system according to claim 15, wherein the cost function takes into account delivery time, fuel consumption of a delivery vehicle and freshness of the goods.

20. The system according to claim 11, wherein the electronic device is selected from a group including: a cellular phone, a smartphone, a personal computer (PC), a laptop PC, and a tablet PC.
